(19) United States
(12) Patent Application Publication
(10) Pub. No.: US 2022/0277010 A1
(43) Pub. Date: Sep. 1, 2022

(54) HASH BASED SET OPERATIONS

(71) Applicant: Oracle International Corporation, Redwood Shores, CA (US)

(72) Inventors: Yuan Zhou, Foster City, CA (US); Huagang Li, San Jose, CA (US)

(21) Appl. No.: 17/186,969

(22) Filed: Feb. 26, 2021

(51) Int. Cl. G06F 16/2453; G06F 16/22; G06F 16/2455

(52) U.S. Cl. CPC G06F 16/24545; G06F 16/2255; G06F 16/24556

(57) ABSTRACT

Computer-implemented techniques for hash-based set operations. In some embodiments, the techniques are implemented in a computer database management system to improve the computational space or time efficiency of executing database query language statements that contain one or more set operations. With the hash-based techniques, duplicate record elimination and aggregation of the component query result sets is not required before combining the sets in a set operation as the set operation itself performs aggregation on the records. As a result, the computational efficiency of performing the set operation is improved over a sort-based approach where a component query result set is not pre-sorted.

### CROSS-REFERENCE TO RELATED APPLICATIONS

This application is related to U.S. patent application Ser. No. 14/170,392 filed Jan. 31, 2014 and issued as U.S. Pat. No. 9,535,956 on Jan. 3, 2017.

### FIELD OF THE INVENTION

The present invention relates to computer-implemented set operations such as, for example, set operations implemented by a computer database management system.

### BACKGROUND

Many computer applications need to perform set operations. A set operation combines two data sets into a single data set. In the context of computer database management system, a set operation combines the result sets of two component queries into a single query result set. The way the component query result set are combined varies depending on the kind of set operation. Some kinds of set operations include MINUS, INTERSECT, MINUS ALL, and INTERSECT ALL.

The set operation A MINUS B determines all distinct query results that occur in set A but not in set B. The set operation A INTERSECT B determines all distinct query results that occur in both sets A and B. The MINUS ALL and INTERSECT ALL operations are the same as their non-ALL counterparts with the difference that duplicates are retained in the result set.

One way to implement a set operation in a database management system is to use a sort-based approach. With the sort-based approach, the component query result sets A and B are sorted, and the sorted sets A and B are scanned sequentially in sorted order to combine them according to the particular set operation. It may happen that the sets A and B are pre-sorted in the expected order such that the sets do not need to be sorted as part of the set operation itself. For example, set A or B or both sets A and B may be stored in computer memory in the sorted order before the set operation is performed. However, if a set A or B is not pre-sorted, then the set is sorted by the set operation. This sorting contributes— in some cases substantially— to the latency of the set operation.

As an example of the sort-based approach, consider the following Structured Query Language (SQL) statement. This statement can be executed by a database management system against a database to determine a query result set using the sort-based approach to perform the set operations:

### Q1: SELECT X FROM T1 MINUS SELECT X FROM T2 MINUS SELECT X FROM T3;

The above SQL statement Q1 contains two MINUS set operations. The statement does not override the default operation precedence such as by using parentheses. As such, the database management system may execute the set operations left to right in the given order. In particular, the set operation A MINUS B may be performed first where set A consists of the records that result from executing component query SELECT X FROM T1 against database object T1 of the database. Set B consists of the records that result from executing component query SELECT X FROM T2 against database object T2 of the database. Then, the set operation C MINUS D may be performed where set C consists of the records that result from the set operation A MINUS B and set D consists of the records that result from executing component query SELECT X FROM T3 against database object T3 the database. A database object (e.g., T1, T2, or T3) may be a table, a partition, a view, a materialized view, an index, or other database object that is used to store or reference database data. To execute the SQL statement according to the sort-based approach, each of sets A, B, and D are either pre-sorted or sorted by the database management system as part of executing the SQL statement. In a test situation where none of A, B, or D is pre-sorted, the sorting of sets A, B, and D has been observed to consume approximately one-half of the time spent by the database management system executing the SQL statement.

As a visual example, FIG. 1 is a pictorial depiction of the database management system processing the SQL statement SELECT FN FROM T1 MINUS SELECT FN FROM T2 according to the sort-based approach. In this example, set A consists of four results of executing the component query SELECT FN FROM T1 against database object T1 of the database and set B consists of four results of executing the component query SELECT FN FROM T2 against database object T2 of the database. The sets A and B are sorted with duplicates removed. As a result of the set operation A MINUS B, result set C is produced. Result set C includes the results in set A that are not in set B with duplicates removed. To produce result set C, since sets A and B are sorted, the database management system can proceed sequentially through sets A and B performing comparisons between records in the sets along the way until the end of set A has been reached. If sets A and B are pre-sorted, then the set operation can be performed efficiently. However, if the set operation is required to first sort either or both sets A and B, then the set operation can take much longer to complete.

The execution of a SQL statement according to the sort-based approach containing INTERSECT ALL or MINUS ALL set operations is roughly like the non-ALL case discussed above. However, duplicates in the sorted sets are aggregated by a count that represents the number of repeats of a record in the set. The counts are then used to perform the ALL operation. For example, consider the following SQL statement:

### Q2: SELECT X FROM T1 INTERSECT ALL

SELECT X FROM T2 MINUS ALL
SELECT X FROM T3;

The above SQL statement Q2 contains two set operations. In particular, the set operation A INTERSECT ALL B may be performed first where set A consists of the records that result from executing component query SELECT X FROM T1 against database object T1 of the database. Set B consists of the records that result from executing component query SELECT X FROM T2 against database object T2 of the database. Then, the set operation C MINUS ALL D may be performed where set C consists of the records that result from the set operation A INTERSECT ALL B and set D consists of the records that result from executing component query SELECT X FROM T3 against database object T3 the database. To execute the SQL statement according to the sort-based approach, each of sets A, B, and D are either pre-sorted or sorted by the database management system as part of performing the set operations of the SQL statement. However, for an ALL set operation, for each record in a set input to the ALL set operation that has a duplicate in the set, a count of the number of duplicates of the record in the set is maintained. When performing the ALL set operation, the counts are used to produce a result set with the correct number of duplicate records.

Approaches that increase the computational space or time efficiency of performing set operations would be appreciated, especially in the database arts.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a sort-based set operation.

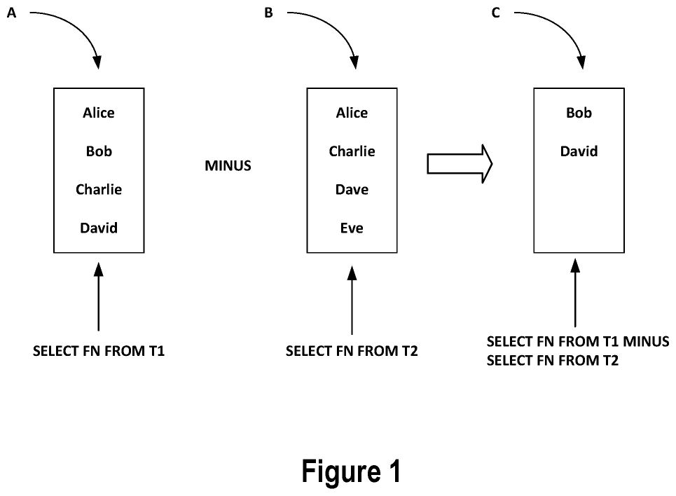

FIG. 2 depicts a hash map and a set of packed records stored in a computer memory, according to some embodiments of the present invention.

FIG. 3 depicts a hash map and a set of packed records distributed over multiple computing nodes, according to some embodiments of the present invention.

FIG. 4 depicts example packed record formats, according to some embodiments of the present invention.

FIG. 5 is a flowchart of a process for initially populating a hash map based on the build branch of a two-branch database query language statement that includes a MINUS or INTERSECT set operation, according to some embodiments of the present invention.

FIG. 6 is a flowchart of a process for probing a hash map based on the probe branch of a two-branch database query language statement that includes a MINUS set operation, according to some embodiments of the present invention.

FIG. 7 is a flowchart of a process for probing a hash map based on the probe branch of a two-branch database query language statement that includes an INTERSECT set operation, according to some embodiments of the present invention.

FIG. 8 is a flowchart of a process for initially populating a hash map based on the build branch of a two-branch database query language statement that includes a MINUS ALL or an INTERSECT ALL set operation, according to some embodiments of the present invention.

FIG. 9 is a flowchart of a process for probing a hash map based on the probe branch of a two-branch database query language statement that includes a MINUS ALL set operation, according to some embodiments of the present invention.

FIG. 10 depicts an example of how work area metadata values of a packed record change for a multiple branch database query language statement that includes an INTERSECT ALL set operation, according to some embodiments of the present invention.

FIG. 11 is a block diagram of an example basic computing device with which an embodiment of the present invention may be implemented.

FIG. 12 is a block diagram of an example basic software system for controlling the operation of the basic computing device of FIG. 11.

### DETAILED DESCRIPTION

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

### General Overview

Computer-implemented techniques for hash-based set operations are disclosed. In some embodiments, the techniques are implemented in a computer database management system to improve the computational space or time efficiency of executing database query language statements that contain one or more set operations. With the hash-based techniques, duplicate record elimination and aggregation of the component query result sets is not required before combining the sets in a set operation as the set operation itself performs aggregation on the records. As a result, the computational efficiency of performing the set operation is improved over the sort-based approach where a component query result set is not pre-sorted.

The techniques may be implemented as a replacement for or in conjunction with a sort-based approach for implementing set operations. For example, when generating a query execution plan for a given query language statement containing one or more set operations, the database management system may compute computational cost estimates for executing the given query using the hash-based approach versus executing the given query using the sort-based based approach. The system may then execute the given query using the approach that is estimated to be the lower cost.

Further, while the techniques for hash-based set operations may be used to avoid sorting component query result sets that are input to a set operation, the techniques are not incompatible with such sorting. There is no requirement of the hash-based approach that the component query result sets not be sorted.

### Branches

The term “branch” is used herein to refer generally to a set of zero or more records that are input to a set operation. Each record encompasses one or more fields. Each field encompasses a value of the record. For example, a field value of a record can be a string or numerical value represented in a computer as a sequence of one or more bytes or other data units. In the context of a database management system, a record may correspond to a row of a database object or a row in a query result set, a field may correspond to a column of the row, and a field value may correspond to the value of the column.

A branch can be a query result set of component query that is input to a set operation. For example, SQL statement Q3 below involves two branches and SQL statements Q4 and Q5 below both involve three branches.

### Q3: SELECT X FROM T1 INTERSECT SELECT X FROM T2;

### Q4: SELECT N FROM T2 MINUS SELECT N FROM T3 INTERSECT SELECT N FROM T1;

### Q5: SELECT X FROM T1 INTERSECT (SELECT X FROM T2 MINUS SELECT X FROM T3);

The following discussion includes discussion of two different types of branches involved in hash-based set operations. A first type of branch is referred herein to as a “build” branch. A second type of branch is referred to herein as a “probe” branch.

### Build Branches

A build branch is a branch selected to initially populate a hash map when performing a set operation. In contrast to a build branch, a probe branch is a branch that is used to probe a hash map that has been initially populated based on a build branch.

Generally, a hash map, which is sometimes referred to as a hash table, is a data structure for mapping keys to values. A hash function is used to translate a key into a set of one or more entries of the hash map, from which the desired value can be found. The hash function may translate each key to a unique entry in the hash map. However, the hash map implementation can tolerate collisions where the hash function translates different keys to the same set of entries. Different hash map implementations have different strategies for handling collisions. No particular hash map collision strategy is required of the hash-based approach disclosed herein.

For a hash map built from a build branch, the records of the build branch are used in both constructing the keys and the values of the hash map. When building the hash map, the hash function may be applied to a record of the build branch to generate a hash index for the record. When applying the hash function to the record to generate a hash index for the record, the hash function may be applied to all values of all fields of the record. That is, the hash index generated by the hash function for a record may represent a computed digest of the record as a whole including all field values of the record. The computed digest produced by the hash function for a record may encompass a sequence of one or more byte or other data unit values.

When computing a hash index of a record that contains multiple field values, the order of the field values of the record may be ignored or taken into account by the hash function according to the requirements of the particular implementation at hand. In particular, if the order of the field values in the record do not contribute to the uniqueness of the record among the records in the build branch, then the hash function may ignore the field value ordering such that the same hash index is generated for two records having the same set of field values but in different orders. Alternatively, if the field values in the record do contribute to the uniqueness of the record, then the hash function may take the field value order into account such that different hash indices may be generated for two records having the same set of field values but in different orders.

While the hash function can be cryptographic hash function such as a hash function based on the message-digest algorithm (e.g., MD5) or the secure hash algorithm (e.g., SHA-1 or SHA-2), there is no requirement that a keyed or non-keyed cryptographic hash function be used. For example, a cyclic redundancy check (CRC) algorithm, a checksum algorithm, a universal hash function, or a non-cryptographic hash function may be used to generate a key from the field value(s) of a record.

Once the hash index of a record is generated, an entry for the record may be added to the hash map, assuming an entry for the record does not already exist in the hash map. The entry may be associated in the hash map with the hash index generated by the hash function for the record. The entry may contain a pointer to a packed form of the record stored in computer memory. For example, the pointer may be an address in computer memory of where the packed form of the record is stored.

### Packed Records

For computational efficiency, records of the build branch may be stored in a packed form in computer memory. In particular, records of the build branch may be stored in computer memory as “packed” records and entries of the hash map may point to memory locations where the packed records are stored. In this way, data movement within computer memory can be reduced or eliminated when performing hash map operations such as adding a record to the hash map and removing a record from the hash map. Instead, when adding a record to the hash map, a pointer to (e.g., a computer memory address of) the storage location of the record in computer memory can be added to the hash map instead of a copy of the record or its field values. And when removing a record from the hash map, the pointer to the record can be removed from the hash map instead of removing the record or its field values from computer memory. Because pointers are typically much smaller in size than records in terms of amount of computer memory occupied when stored in computer memory, adding and removing pointers to and from computer memory as part of add and remove hash map operations is typically much more computationally efficient than adding and removing records from computer memory as part of add and remove hash map operations.

### Hash Map Example

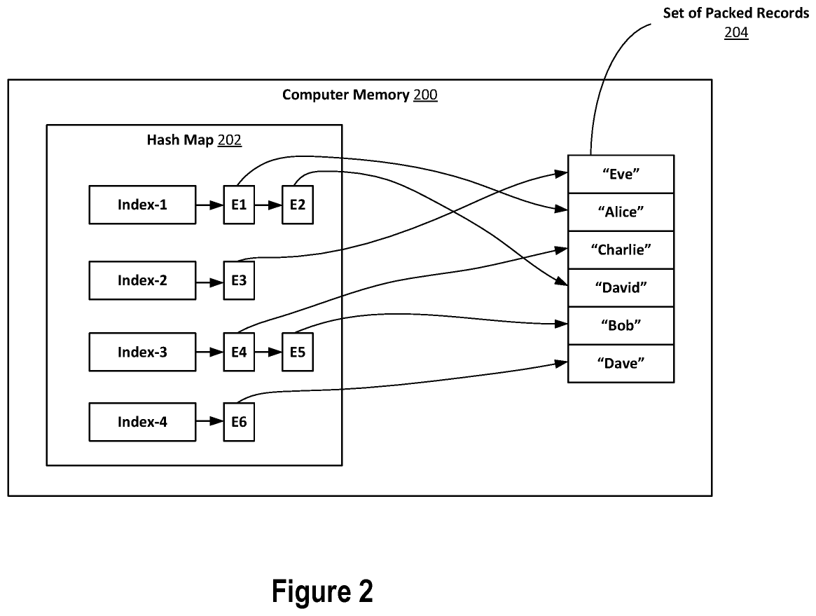

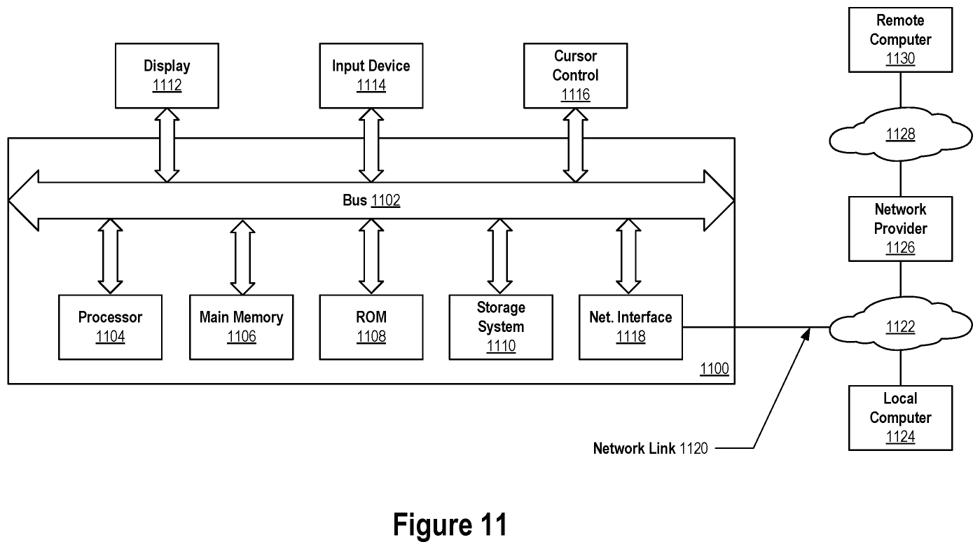

FIG. 2 depicts an example of a hash map that contains entries that point to packed build branch records stored in computer memory. Examples of suitable computer memory 200 include non-volatile or volatile computer memory described below with respect to FIG. 11. Computer memory 200 stores a hash map 202 and a set 204 of packed records.

Each packed record in set 204 corresponds to a unique record of a build branch and includes the field value(s) of the unique record in a packed form. No particular packed form is required. In some implementations, the packed form is type-length-value format or a length-value format. However, other packed formats are possible. For example, a packed record may contain a further pointer to a location in computer memory where the field value(s) of the packed record is/are stored. Encoding formats other than TLV or the like may be used. For example, a human and machine-readable data serialization format may be used (e.g., XML, JSON, or the like). Alternatively, a binary data serialization format may be used (e.g., ProtocolBuffers).

In the simple example of FIG. 2 there are only four hash indices: Index-1, Index-2, Index-3, and Index-4. In a practical implementation, hash map 202 stores many hash indices including up to one hash index for each record of the build branch depending on the number of records of build branch that are mapped to the same hash index by the hash function and depending on the number of records of build branch that are unique. The number of records in a build branch may number into the hundreds, thousands, millions, for example. While hash indices Index-1, Index-2, Index-3, and Index-4 are represented using ordinals 1, 2, 3, and 4 in the example of FIG. 2, the ordinals are used merely to distinguish one hash index from another and not to imply any particular ordering of the hash indices in memory 200.

The hash map includes one entry for each unique record of the build branch. In the simple example of FIG. 2, there are six entries E1, E2, E3, E4, E5, and E6 for six unique records of the build branch. Each entry of the hash map is associated with (mapped to) a corresponding hash index. For example, entries E1 and E2 are associated with (mapped to) hash index Index-1, entry E3 is associated with (mapped to) hash index Index-2, entries E4 and E5 are associated with (mapped to) hash index Index-3, and entry E6 is associated with (mapped to) hash index Index-4. Multiple entries may be mapped to a single hash index when there are collisions in the hash map. For example, entries E1 and E2 mapped to the same hash Index-1 represents one collision and entries E4 and E5 mapped to the same hash index Index-3 represent another collision. While entries E1, E2, E3, E4, E5, and E6 are represented using ordinals 1, 2, 3, 4, 5, and 6 in the example of FIG. 2, the ordinals are used merely to distinguish one entry from another and not to imply any particular ordering of the entries in memory 200.

Each entry in the hash map points to one packed record in the set of packed records derived from a build branch. For example, an entry in hash map 202 may contain the address in memory 200 where the packed record pointed to by the entry is stored. There is no requirement the set of packed records be stored in any particular order within computer memory. Indeed, the hash-based approach disclosed herein may be implemented to avoid having to sort the records of a build branch as may be required of the sort-based approach.

### Probe Branches

As mentioned, in contrast to a build branch, a probe branch is a branch that is used to probe a hash map initially populated based on a build branch. In particular, given a record in the probe branch, a hash index is generated for the record by applying the hash function to the record as is done when generating hash indices for records of the build branch. Then, the hash index generated for the record is used to “probe” the hash map to determine whether the record does or does not exist in the hash map. Depending on whether the record exists in the hash map, various actions are performed depending on the set operation being performed as described in greater detail elsewhere herein.

Reference is made herein to determining whether a record exists, does not exist, or already exists in a hash map. Making this determination generally involves computing a hash index of the record and using the hash index computed for the record to determine whether the hash map contains an entry associated with (mapped to) that hash index for that record. The record may be considered to exist in the hash map if the entry points to a packed record with the same set of field value(s) as the record, and additionally in the same order if required by the particular implementation at hand. If there is no such entry, then the record may be considered to not exist in the hash map.

As used herein, the term “matched record” refers to a record that exists in the build branch and that also exists in a probe branch. A record from the build branch added to the hash map during the build phase may be matched during the probe phase and thus be considered a matched record, if the record exists in a probe branch and a determination is made that the record in the probe branch exists in the hash map.

### Qualifying Set Operations

According to some embodiments, the hash-based approach is used to perform INTERSECT, INTERSECT ALL, MINUS, and MINUS ALL set operations including mixtures thereof. There exist set operations other than INTERSECT, INTERSECT ALL, MINUS, and MINUS ALL. For example, the UNION of two sets produces records that exist in either of the two input sets with duplicates removed. The UNION ALL set operation retains duplicates in the result set.

According to some embodiments, the hash-based approach is not used to perform UNION ALL set operations. However, it is possible to use the hash-based approach for other types of set operations. For example, for the set operation A UNION B, each of sets A and B may be treated as build branches and used to populate the hash map. The set of distinct records in the hash map after the hash map is populated this way may be taken as the result set for A UNION B.

It should also be noted that equivalent set operators may go by different names or symbols in different implementations. For example, the set operation A EXCLUDE B may be equivalent to A MINUS B. Symbology may also be used. For example, the set operation A INTERSECT B may be expressed as A∩B. Thus, while examples are provided herein using certain names for certain set operators, those set operators may be referenced by different names or symbols in a particular implementation of the hash-based approach. As such, no particular names or symbols are required where the set operators are semantically equivalent.

### Partitioned Hash Map

In some embodiments, a hash map built based on a build branch is partitioned over multiple computing nodes. This partitioning may be done so that the building of the hash map and the probing of the hash map can each be performed as a parallel computing operation thereby reducing the latency of the overall operations. In addition, or alternatively, the partitioning may be done so that a large set of packed records can be distributed over a greater amount of computer memory. For example, partitioning may allow the entire or a substantial portion of set of packed records to be stored in faster volatile computer memory where the entire or a substantial portion of the set of packed records would not fit the volatile computer memory of a single computing node.

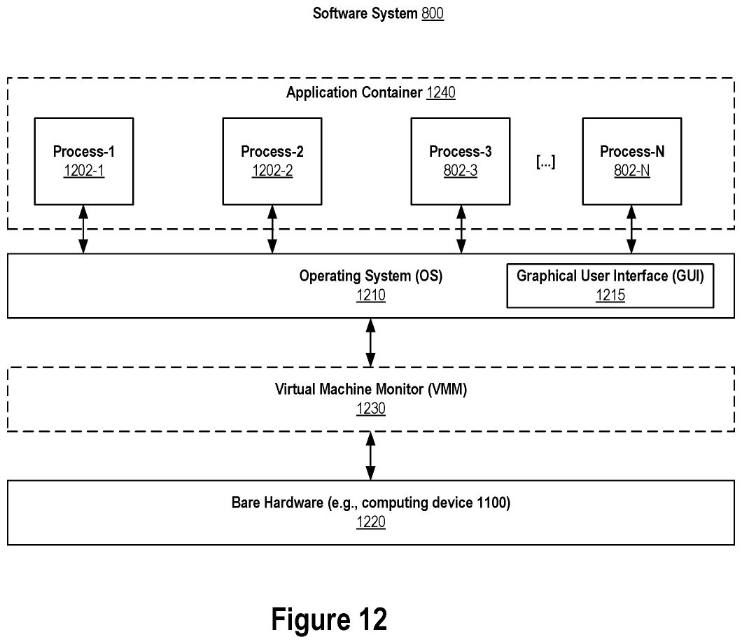

The hash map and the set of packed records may be distributed over two or more computing nodes. A computing node may correspond to a physical computing device such as, for example, computing device 1100 described below with respect to FIG. 11. A computing node may correspond to a guest “virtual” machine such as a guest machine as described below with respect to FIG. 12. Other types of computing nodes are possible and no particular type of computing node is required. Generally, however, each computing node over which the hash map and the set of packed records is distributed is allocated its own computer memory that is not shared with the other computing nodes without cooperation between the computing nodes such as by establishing a shared memory segment.

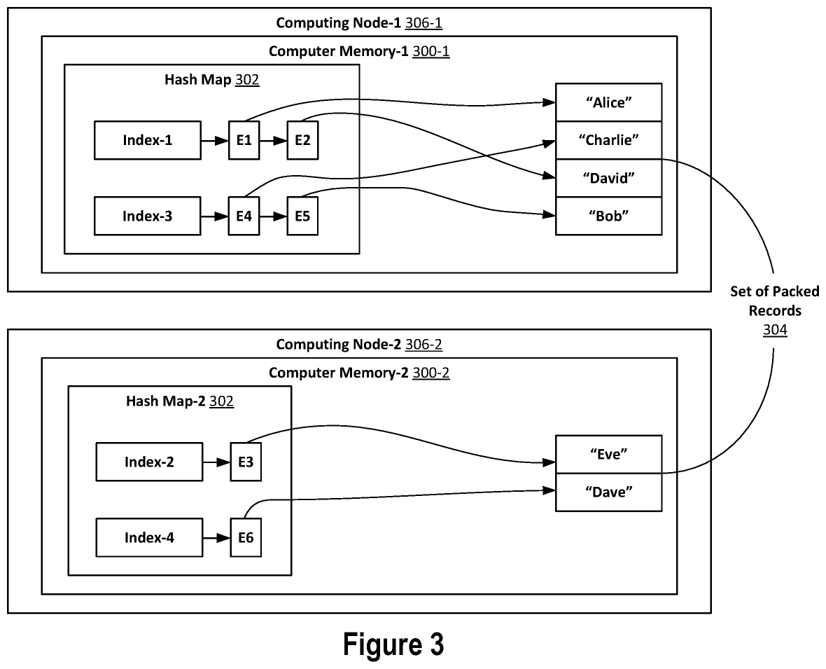

FIG. 3 depicts an example of partitioning hash map 202 and set 204 of packed records of FIG. 2 over two computing nodes 306-1 and 306-2. Hash map 302 corresponds to hash map 202 but distributed over two computing nodes. Likewise, set 304 of packed records correspond to set 204 of packed records but also distributed over two computing nodes.

Two computing nodes are illustrated in the example of FIG. 3 for purposes of providing a clear example. However, more computing nodes may be used in a particular implementation. No particular number of computing nodes is required.

Each record in set 304 of packed records is assigned to one of the computing nodes 306-1 and 306-2. The assignment may be based on the hash index generated for the record. In particular, each computing node 306-1 and 306-2 may be responsible for a respective set of hash indices of hash map 302. The set of hash indices that each computing node 306-1 and 306-2 is responsible for may be range-based, hash-based, or based on another partitioning scheme for assigning hash indices to computing nodes. No particular partitioning scheme is required for assigning hash indices to computing nodes.

In this example, hash indices Index-1 and Index-3 are assigned to computing node 306-1 and hash indices Index-2 and Index-4 are assigned to computing node 306-2. As a result, the entries E1, E2, E4, and E5 of hash map 302 associated with hash indices Index-1 and Index-3 are stored in computer memory-1 300-1 of computing node-1 306-1 and the entries E3 and E6 of hash map 302 associated with hash indices Index-2 and Index-4 are stored in computer memory-2 300-2 of computing node 306-2. Also, the packed records of set 304 that are pointed to by entries E1, E2, E4, and E5 are stored in computer memory-1 300-1 of computing node-1 306-1 and the packed records of set 304 that are pointed to be entries E3 and E6 are stored in computer memory-2 300-2 of computing node-2 306-2.

By partitioning hash map 302 and set 304 of packed records, operations for building hash map 302 involving hash indices Index-1 and Index-3 can be performed in parallel with operations for building hash map 302 involving hash indices Index-2 and Index-4. Likewise, operations for probing hash map 302 involving hash indices Index-1 and Index-3 can be performed in parallel with operations for probing hash map 302 involving hash indices Index-2 and Index-4.

References herein to a hash map and a set of packed records is intended to encompass both partitioned and non-partitioned implementations, unless the context clearly indicates otherwise. In partitioned implementations, the build, probe, scan, and produce operations can each be parallelized. For example, each computing node of a partitioned implementation may perform the build, probe, scan, and produce operations in parallel on their respective portions of the hash map and the set of packed records. The incomplete set of records produced by each computing node can then be combined into a complete set of records that is the result of the set operation.

### Packed Record Work Area

According to some embodiments, a packed record stored in computer memory includes several bytes representing a work area used by the hash-based approach. These work area bytes of the packed record are in addition to the bytes representing the field value(s) of the packed record. The packed record may have different work area formats depending on the number of branches involved in the particular database query language statement being executed and the particular set operation(s) of the statement. The use and maintenance of the work area is described in greater detail elsewhere in this disclosure. However, in general, the work area is used to perform record-level aggregations when building and probing the hash map.

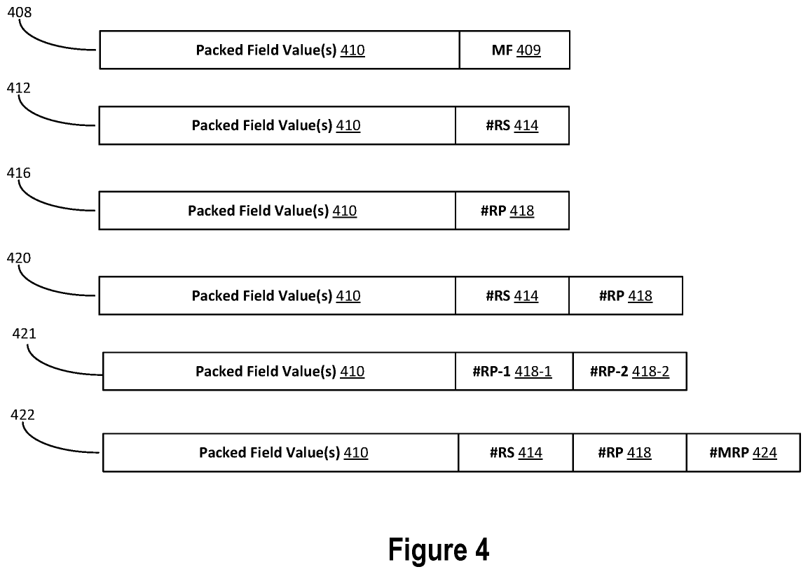

FIG. 4 depicts example packed record formats with different work areas, according to some embodiments of the present invention. Each of the different formats 408, 412, 416, 420, 422, and 425 include packed field value(s) 410 corresponding to the field value(s) of the corresponding build branch record.

Format 408 includes a matched flag 409 which is abbreviated herein as MF flag 409. The MF flag 409 is a Boolean value (e.g., a single bit value) that indicates whether the represented record was matched during the probe phase.

Format 412 includes a number of probe branches field 414 which is abbreviated herein as #RS field 414. #RS field 414 tracks a number of probe branches in which the represented record appears. In some embodiments, #RS field 414 is used when there is more than one probe branch involved in processing a query language statement. However, #RS field 414 may be used when there is only one probe branch.

Format 416 includes a number of repeats field 418 which is abbreviated herein as #RP field 418. #RP field 418 tracks a number repeats of the represented record in a branch.

Format 420 includes #RS field 414 and #RP field 418. In some embodiments, format 420 is used for processing database query language statements that contain both a MINUS ALL set operation and an INTERSECT set operation.

Format 421 includes two #RP fields 418 for use in the two branch INTERSECT ALL case as described below, in some embodiments.

Format 422 includes #RS field 414, #RP field 418, and a number of previous repeats field 424 which is abbreviated herein as #MRP field 424. #MRP field 424 tracks of a minimum number of repeats of the represented record among previous branches. In some embodiments, format 422 may be used for processing database query language statements that contain any mixture of ALL and non-ALL set operations that includes an INTERSECT ALL set operation.

In some embodiments, MF flag 409 is a single bit in size. However, MF flag 409 may encompass more bits according to the requirements of the particular implementation at hand.

In some embodiments, #RS field 414 is two bytes in size. However, #RS field 414 may encompass fewer or more bytes according to the requirements of the particular implementation at hand.

In some embodiments, #RP field 418 is eight bytes in size. However, #RP field 418 may encompass fewer or more bytes according to the requirements of the particular implementation at hand.

In some embodiments, #MRP field 424 is eight bytes in size. However, #MRP field 424 may encompass fewer or more bytes according to the requirements of the particular implementation at hand.

While in some embodiments the work area for a packed record is part of the packed record itself, the work area for a packed record is stored separate from the packed record in other embodiments. For example, the work area for a packed record can be stored in a separate data structure (e.g., a work area index) or in a separate part of computer memory from the packed record.

While in some embodiments the work area of a packed record is stored at the end of the packed record following the field value(s), the work area is stored as a header of the packed record in other embodiments. It is also possible to store some of the work area as a header and another part of the work area at the end of the packed record. No particular placement or location within the packed record is required for the work area.

### Two Branches

As discussed, the hash-based approach can be used to perform certain set operation(s) in a database query language statement. This section will discuss the two-branch case where the database query language statement contains a single set operation with two branches as input to the set operation. A following section discusses extensions of the two-branch case to database query language statements that involve more than two branches and more than one set operation.

In general, in a build phase, the hash-based approach initially populates a hash map based on the records of one of the two branches of the set operation. In a probe phase, the hash map is then probed with the records of the other of the two branches. Record-level aggregation may also be performed during the build and probe phases. The rules of the aggregation performed vary depending on the type of set operation. In particular, the aggregation rules vary depending on whether the set operation is MINUS, INTERSECT, INTERSECT ALL, or MINUS ALL. After the build and probe phases, records in the hash map are scanned (scan phase) and based on the scan a result set of records for the set operation is produced (produce phase).

With regard to the build phase, a hash index is computed for each record of the build branch. If the record does not already exist in the hash map, then the record is packed and stored in computer memory and the packed record is added to the hash map.

During the probe phase, a hash index is computed for each record of the probe branch. If the record exists in the hash map, then aggregation may be performed on the corresponding packed record stored in computer memory during the build phase.

In contrast to a sort-based approach, the records of the build and probe branches do not need to be sorted before the build and probe phases of the hash-based approach.

### Two Branches— Build Phase— Minus or Intersect

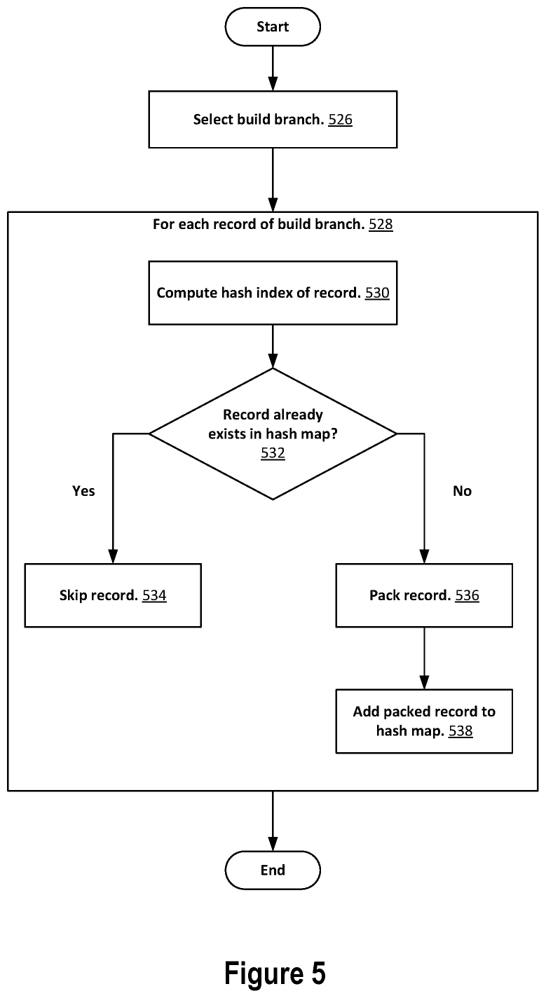

FIG. 5 is a flowchart of a process of a build phase for an A MINUS B or an A INTERSECT B set operation in the two-branch case, according to some embodiments of the present invention. The process and the operations thereof may be performed by a database management system executing on one or more computing devices.

Examples of database query language statements that encompass an A MINUS B set operation or an A INTERSECT B set operation are example queries Q6 and Q7 below:

### Q6: SELECT N FROM TI MINUS SELECT N FROM T2;

### Q7: SELECT N FROM TI INTERSECT SELECT N FROM T2;

In both of the above-example queries, the resulting set of records from executing the component query SELECT N FROM T1 against the database object T1 is one input branch to the set operation and the result set of records from executing the component query SELECT N FROM T2 against the database object T2 is another input branch to the set operation.

Returning again to FIG. 5, at operation 526, one of the two input branches is selected as the build branch.

If the set operation is A MINUS B, then the input branch A is selected 526 as the build branch as the result of the set operation may include all unique records in set A or a subset thereof.

If the set operation is A INTERSECT B, then A INTERSECT B is equivalent to B INTERSECT A because of the commutative property of INTERSECT. Thus, for an A INTERSECT B set operation, the build branch can be either A or B.

In some embodiments, the branch A or B with the fewer number of distinct records is selected 526 as the build branch. By doing so, the size of the hash map is minimized. The number of distinct records for an input branch may be determined based on query optimization statistics maintained by the database management system. The number of distinct records may be an accurate count of the number of distinct records in the input branch or an estimate thereof.

In some embodiments, the database query language statement includes a hint that specifies which input branch to use as the build branch. The branch specified by the hint may then be selected 526 as the build branch. The hint may be ignored by the database management system if it is invalid or conflicts with other hints in the database query language statement.

Example statement Q9 below is an example of a database query language statement that includes a build branch hint:

### Q8: SELECT N FROM TI INTERSECT SELECT/*+HASHSET_BUILD*/N FROM T2;

In the above example statement Q8, the query language syntax/*+HASHSET_BUILD*/ is used to indicate that the result set of executing the component query SELECT N FROM T2 should be used as the build branch. Other syntax may be used as the hint and expressing a build branch hint is not limited to the syntax of this example.

Once the build branch is selected 526, operation 528 is performed for each record in the build branch.

At operation 530, a hash index is computed for the current record by applying the hash function of a hash map to the record.

At operation 532, the hash index computed for the current record at operation 530 is used to determine whether the current record was previously added to the hash map during the build phase.

If the current record was already added to the hash map during the build phase, then the current record is skipped 534 and operation 528 repeats again for the next current record, if there are more records in the build branch that have yet to be processed during the build phase.

On the other hand, if the current record does not exist in the hash map, then the current record is packed 536 in computer memory in a packed form. The current record is then added to the hash map by adding 538 an entry to the hash map associated with the hash index computed at operation 530 for the current record. The hash map entry is configured to point to a location in computer memory where the packed record created at operation 536 for the current record is stored. For example, the hash map entry may contain the computer memory address of the location.

### Two Branches— Probe Phase— Minus

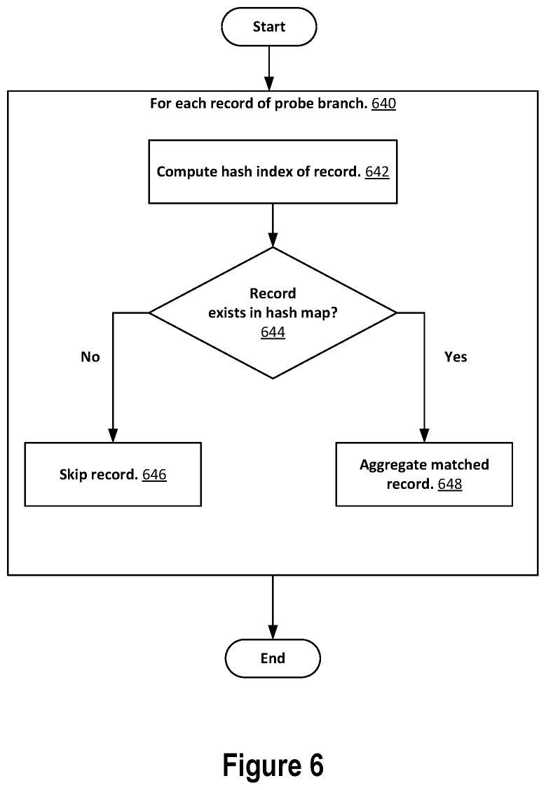

Turning now to FIG. 6, it is a flowchart of a process of a probe phase for an A MINUS B set operation in the two-branch case, according to some embodiments of the present invention. The process and the operations thereof may be performed by a database management system executing on one or more computing devices. The process of FIG. 6 may be performed in conjunction with the process of FIG. 5 where a hash map is initially built based on a build branch.

Operation 640 is performed for each record in the probe branch.

At operation 642, a hash index in computed for the current record by applying the hash function of the hash map to the record.

At operation 644, the hash index computed for the current record at operation 642 is used to determine whether the current record exists in the hash map.

If the current record does not exist in the hash map, then, at operation 646, aggregation of the current record is skipped.

On the other hand, if the current record exists in the hash map, then, at operation 648, the current matched record is aggregated by removing the matched record from the hash map. This removing is done because the current record is in both the build branch and the probe branch and thus is not to be included in the result set of A MINUS B. Removing the current record from the hash map may involve configuring the pointer of the entry in the hash map for the current record so that the hash map no longer points to a location of the corresponding packed record in computer memory. For example, the pointer of the entry can be set to a NULL value or zero or otherwise set to not point to a packed record. Alternatively, the entry may be removed from the hash map. In either case, the packed record can remain in computer memory and does not need to be removed from the computer memory.

In some embodiments, the packed record for the current record includes or is associated with a work area that encompasses MF flag 409. For example, MF flag 409 of the packed record can be a single bit of the packed record. MF flag 409 indicates whether the current record was matched during the probe phase. MF flag 409 for the packed record may initially be set to a value (e.g., zero or false) indicating that the current record has not been matched during the probe phase. For example, MF flag 409 may be set to this initial value in operation 536 described above with respect to FIG. 5 when the current record was initially packed in computer memory. Then, at operation 648, MF flag 409 can be updated to a different value to indicate that the current record was matched during the probe phase. Note that if it is determined at operation 644 that the current record is not in the hash map, then MF flag 409 of the corresponding packed record may not be updated from its initial not matched value.

MF flag 409 may be used during the scan and produce phases as described below.

### Two Branches— Scan and Produce Phases— Minus

After the build and probe phases are complete, the set of packed records may be scanned to produce the result set of the A MINUS B set operation. In particular, each packed record of the set of packed records may be visited. If, when visiting a packed record during the scan of packed records, MF flag 409 indicates that the corresponding record was not matched during the probe phase (i.e., the record is in set A but not in set B), then the record is produced in the result set. On the other hand, if MF flag 409 indicates that the corresponding record was matched during the probe phase (i.e., the record is in both set A and set B), then the record is not produced in the result set.

As an alternative to scanning the set of packed records, the set of entries in the hash map may be scanned. If, when visiting an entry of the hash map, the entry points to a packed record (i.e., the record is in set A but not in set B), then the corresponding record is produced in the result set. On the other hand, if the entry is not pointing to a packed record (i.e., the record is both set A and set B), then no record is produced in the result set for that entry.

The database management system may select one of the above two scanning and producing approaches based on the number of distinct records not matched during the probe phase. All such records are produced in the result set of the A MINUS B set operation. If the number of distinct records not matched is a majority or most of the records in the set of packed records, then scanning the set of packed records may be preferred over scanning the hash map entries to avoid the overhead of also accessing a majority or most of the entries of the hash map in computer memory during the scan. For example, if the total number of distinct records not matched is equal to or greater than a threshold percentage (e.g., >50%) of the total number of packed records in the set of packed records, then scanning the set of packed records may be preferred over scanning the entries of the hash map. The total number of distinct records not matched may be counted or estimated during the probe phase so that counting these records is not needed as an initial step during the scan phase. Otherwise, scanning entries of the hash map may be preferred because packed records that are not pointed to by an entry of the hash map because they were disconnected from the hash map by operation 648 described above do not need to be accessed in computer memory during the scan of the hash map entries to produce the result set of A MNUS B. Thus, if the number of distinct records not matched is below the threshold, then the hash map scan may be preferred.

As an alternative, the total number of distinct records matched may be counted or estimated during the probe phase. In this case, if the count or estimate is equal to or less than a threshold percentage (e.g., <50%) of the total number of packed records in the set of packed records, then scanning the set of packed records may be preferred over scanning the entries of the hash map. Otherwise, scanning the entries of the hash map may be preferred.

In some embodiments where MF flag 409 is not used, the hash map scan is performed for entries that point to packed records. In some embodiments where matching records are not removed from the hash map, the scan of the set of packed records is performed for packed records where MF flag 409 is not set.

### Two Branches— Probe Phase— Intersect

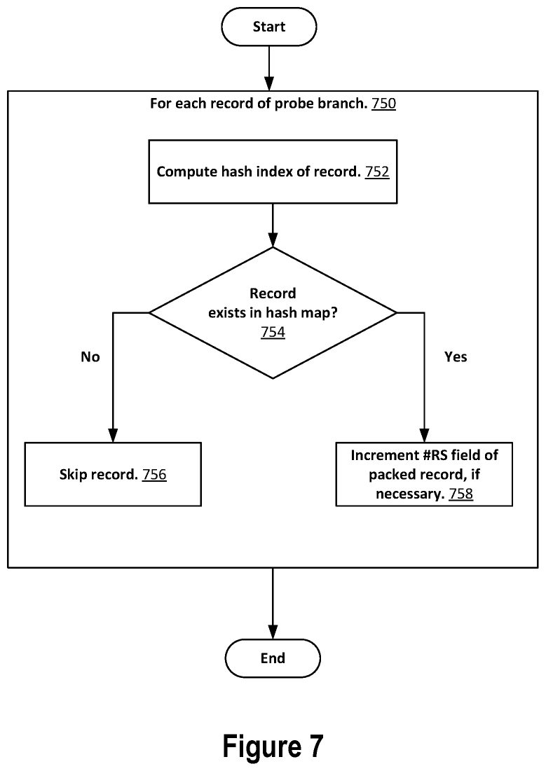

Turning now to FIG. 7, it is a flowchart of a process of a probe phase for an A INTERSECT B set operation in the two-branch case, according to some embodiments of the present invention. The process and the operations thereof may be performed by a database management system executing on one or more computing devices. The process of FIG. 7 may be performed in conjunction with the process of FIG. 5 where a hash map is initially built based on a build branch.

Operation 750 is performed for each record in the probe branch.

At operation 752, a hash index in computed for the current record by applying the hash function of the hash map to the record.

At operation 754, the hash index computed for the current record at operation 752 is used to determine whether the current record was added to the hash map during the build phase.

If the current record was not added to the hash map during the build phase, then, at operation 756, aggregation of the current record is skipped.

On the other hand, if the current record was added to the hash map during the build phase, then, at operation 758, the value of #RS field 414 of the corresponding packed record is incremented by one if the current value of #RS field 414 of the corresponding packed record is the initial value. The initial value of #RS field 414 of the packed record may be zero or one or other initial value to represent that the current record occurs in the build branch. If the current value of #RS field 414 of the corresponding packed record is greater than the initial value, then there is no need to increment value of #RS field 414 at operation 758 as the value already reflects that the current record exists in both the build branch and the probe branch.

The #RP field 418 of the packed record can be used as a substitute for #RS field 414 discussed above. In particular, if, after the probe phase, the value of #RP field 418 of the packed record is still the initial value (e.g., zero or one), then it can be determined that the corresponding record was not matched during the probe phase (i.e., the current is in set A but not in set B). However, if the value of #RP field 418 is greater than the initial value, then it can be determined that the corresponding record was matched during the probe phase (i.e., the record is in both set A and set B).

While in some embodiments, #RP field 418 is used as a substitute for #RS field 414, MF flag 409 is used an alternative to #RS field 414 in other embodiments. In this case, MF flag 409 is set if the record occurs in both the build and probe branches and not set if the record occurs only in the build branch.

### Two Branches— Scan and Produce Phases— Intersect

Since records are not removed (disconnected) during the probe phase of A INTERSECT B (unlike A MINUS B), the scan phase for intersect may use a scan of the set of packed records instead of a scan of the hash table entries to avoid the overhead of accessing the hash table entries in computer memory during the scan. In particular, the result set of A INTERSECT B may include records produced for all packed records in the set of packed records where MF flag 409 or #RS field 414 is set indicating that a match was made with the record during the probe phase or where the value of #RP field 418 of the packed record is greater than an initial value. If MF flag 409 or #RS field 414 is not set or the value of #RP field 418 is still the initial value, then a record for the packed record is not produced in the result set.

### Two Branches— Build Phase— Minus all or Intersect all

In the MINUS ALL case, #RP field 418 may be maintained for each packed record. In the INTERSECT ALL case, two instances of #RP field 418 may be used for each packed record. With MINUS ALL or INTERSECT ALL, any repeats should be preserved in the result set. For example, five (5) instances of “Alice” MINUS ALL two (2) instances of “Alice” is three instances of “Alice”. As another example, five (5) instances of “Alice” INTERSECT ALL two (2) instances of “Alice” is two (2) instances of “Alice”.

Accordingly, for A MINUS ALL B, each time a repeat of a record in the build branch is seen during the build phase, the value of #RP field 418 of the corresponding packed record is incremented by one. Each time the record is matched during the probe phase, the value of the #RP field 418 of the corresponding packed record is decremented by one. After the probe phase, the number of instances of the record to produce in the result set of A MINUS ALL B may be equal to the value of the #RP field 418 of the corresponding packed record for values greater than or equal to one (1).

For A INTERSECT ALL B, each time a repeat of a record in the build branch is seen during the build phase, the value of one #RP field 418 of the corresponding packed record is incremented by one. Each time the record in the probe branch is seen during the probe phase, the value of another #RP field 418 of the corresponding packed record is incremented by one. Where the values of both #RP fields are greater than or equal to one, the number of instances of the record to produce in the result set of A INTERSECT ALL B may be equal to the minimum of the two values.

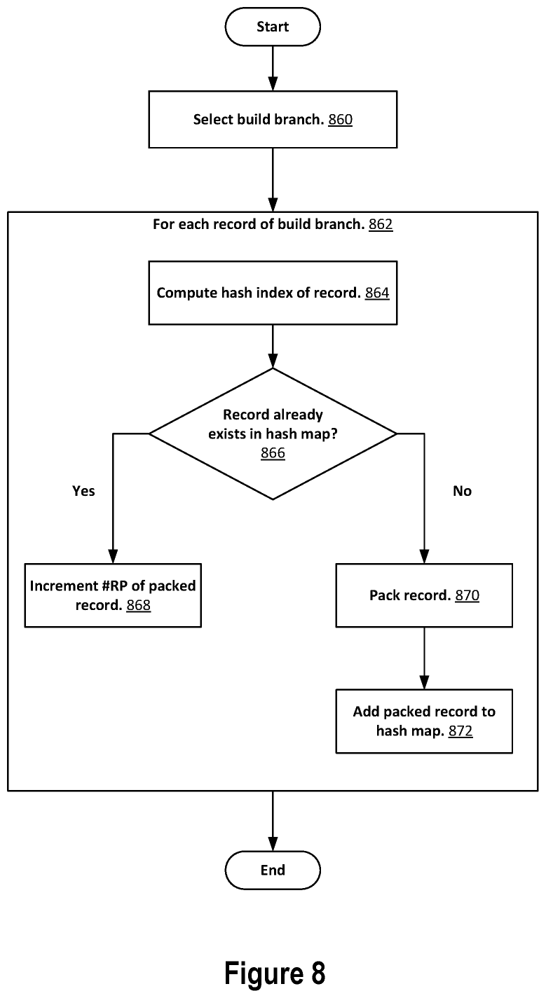

FIG. 8 is a flowchart of a process of a build phase for an A MINUS ALL B or an A INTERSECT ALL B set operation in the two-branch case, according to some embodiments of the present invention. The process and the operations thereof may be performed by a database management system executing on one or more computing devices.

Examples of database query language statements that encompass an A MINUS ALL B set operation or an A INTERSECT ALL B set operation are example queries Q9 and Q10 below:

### Q9: SELECT N FROM TI MINUS ALL SELECT N FROM T2;

### Q10: SELECT N FROM TI INTERSECT ALL SELECT N FROM T2;

In both of the above-example queries, the resulting set of records from executing the component query SELECT N FROM T1 against the database object T1 is one input branch to the set operation and the result set of records from executing the component query SELECT N FROM T2 against the database object T2 is another input branch to the set operation.

Returning again to FIG. 8, at operation 860, one of the two input branches is selected as the build branch.

If the set operation is A MINUS ALL B, then the input branch A is selected 860 as the build branch as in the A MINUS B case discussed above with respect to FIG. 5.

If the set operation is A INTERSECT ALL B, then A INTERSECT ALL B is equivalent to B INTERSECT ALL A because of the commutative property of INTERSECT ALL. Thus, for an A INTERSECT ALL B set operation, the build branch can be either A or B. In this case, the build branch A or B that is selected 860 can be based on the branch with the fewer number of distinct records or based on a query hint as in the A INTERSECT B case discussed above with respect to FIG. 5.

Once the build branch is selected, operation 862 is performed for each record in the build branch.

At operation 864, a hash index is computed for the current record by applying the hash function of a hash map to the record.

At operation 866, the hash index computed for the current record at operation 864 is used to determine whether the current record was already added to the hash map during the build phase.

If the current record is already added to the hash map during the build phase, then the value of an #RP field 418 of the corresponding packed record is incremented 868 (e.g., by one). If the set operation is A MINUS ALL B, then the packed record may have only one #RP field 418. However, if the set operation is A INTERSECT ALL B, then the packed record may have two #RP fields, one of the build branch and one for the probe branch. If the set operation is A INTERSECT ALL B, then the #RP field 418 for the build branch is incremented 868.

If the current record has not yet been added to the hash map during the build phase, then the current record is packed 870 in computer memory in a packed form. If the set operation is A MINUS ALL B, then the value of the #RP field 418 is set to an initial value (e.g., one) indicating that the current record occurs at least once in the build branch. If the set operation is A INTERSECT ALL B, then the value of the #RP field 418 for the build branch is set to an initial value (e.g., one) indicating that the current record occurs at least once in the build branch and the value of the #RP field 418 for the probe branch is set to an initial value (e.g., zero) indicating that it is currently unknown how many times the current record occurs in the probe branch. The current record is than added 872 to the hash map by adding an entry to the hash map associated with the hash index computed at operation 864 for the current record where the entry points to a location in computer memory where the packed record created at operation 870 for the current record is stored.

### Two Branches— Probe Phase— Minus all and Intersect all

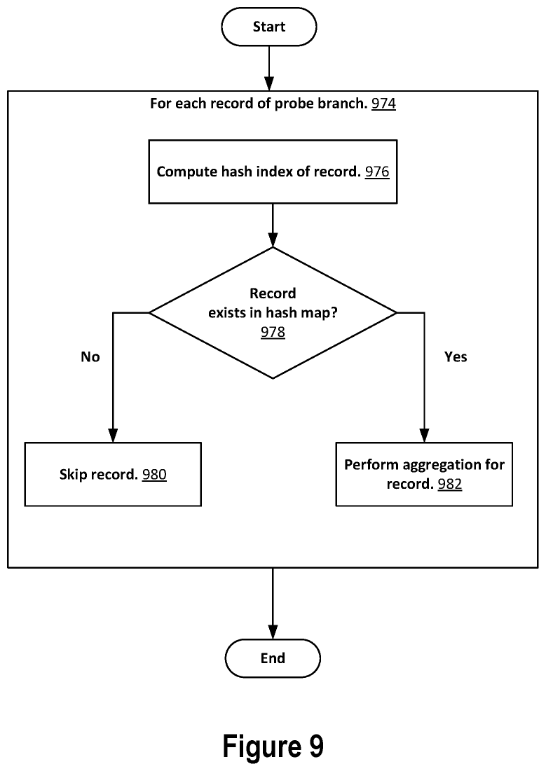

Turning now to FIG. 9, it is a flowchart of a process of a probe phase for an A MINUS ALL B set operation or an A INTERSECT ALL B in the two-branch case, according to some embodiments of the present invention. The process and the operations thereof may be performed by a database management system executing on one or more computing devices. The process of FIG. 9 may be performed in conjunction with the process of FIG. 8 where a hash map is initially built based on a build branch.

Operation 974 is performed for each record in the probe branch.

At operation 976, a hash index in computed for the current record by applying the hash function of the hash map to the record.

At operation 978, the hash index computed for the current record at operation 976 is used to determine whether the current record exists in the hash map (i.e., to determine whether the current record is in set A).

If the current record does not exist in the hash map, then, at operation 980, aggregation of the current record is skipped.

On the other hand, if the current record exists in the hash map, then, at operation 982, then aggregation for the current record is performed in the corresponding packed record. The aggregation performed at operation 982 varies depending on the set operation.

If the set operation is A MINUS ALL B, then the value of the #RP field 418 of the packed record is decremented (e.g., by one). If the value of the #RP field 418 is zero or below the initial value after the decrement, then the current record may be removed from the hash map by removing or disconnecting the entry in the hash map that points to the packed record such that the hash map no longer points to the packed record. In addition, MF flag 409 of the packed record may be set (or unset) to indicate that the current record should not be included in the result set for A MINUS ALL B.

If the set operation is A INTERSECT ALL B, then the value of the #RP field 418 for the probe phase of the packed record is incremented.

### Two Branches— Scan and Produce Phases— Minus all and Intersect all

The scan and produce phases for A MINUS ALL B can operate like A MINUS B as described above. However, when producing a record in the result set for A MINUS B, the number of instances of the record to produce in the result set may be determined by the value of the #RS field 418 of the corresponding packed record. For example, the number of instances of the record to produce may be equal to the value.

The scan and produce phases for A INTERSECT ALL B can operate like A INTERSECT B as described above. However, when producing a record in the result set for A INTERSECT ALL B, the number of the instances of the record to produce may be determined by the value of the #RP field 418 for the build phase and the value of the #RP field for the probe phase from the corresponding packed record. For example, the number of instances of the record to produce may be equal to the minimum of the two values if the record occurs at least once in both set A and set B.

### Produce Phase Optimization

When multiple instances of a record are to be produced in a result set, instead of the result set including multiple copies of the record, the result set can include one copy of the record along with a numerical count that specifies the number of instances of the record in the result set. With this representation, the result set may occupy a smaller amount of space in computer memory. The result set with the counts may then be provided to another process (e.g., a row consumer process) for further processing.

Note that this reduce phase optimization may also be used in a partitioned hash map implementation in which each computing node produces an incomplete result set with records and instance counts. The incomplete result sets can then be combined into a final result set with records and instance counts. For each unique record in the final result set, the instance count can be determined as the sum of the instance counts for the record from each of the incomplete result sets.

### Extension to Multiple Branches

The two-branch hash-based approaches described above can be extended to database query language statements that have multiple branches (i.e., more than two branches). With a multiple branch query, the set operation on each branch may not be the same. If the query involves a mixture of set operations, then, for certain mixtures of set operations, all of the set operations can be performed with a single build phase and a single build branch. For example, consider the following query statement Q11:

Q11: Select N from T2 Minus Select N from T3 Intersect Select N from T1;

The above query may be viewed generally as A MINUS B INTERSECT C. Set A may be selected as the build branch. Set B may be selected as a first probe branch and the set operation A MINUS B may be performed as in the two-branch case described above. The resulting hash map reflects the result set of A MINUS B or set D. Set C may then be selected as a second probe branch and the set operation D INTERSECT C may be performed as in the two-branch case described above but without having to perform an additional build phase since the hash map already reflects set D. The result set for D INTERSECT C may then be produced as in the two-branch case described above to produce the result set for A MINUS B INTERSECT C.

Reducing the number of hash maps that need to be built to produce a result set for a multiple branch query is important as allocating and deallocating a hash map and entries thereof in computer memory can be computationally costly. For example, consider the following query statement Q12:

### Q12: SELECT N FROM T1 INTERSECT (SELECT N FROM T2 MINUS SELECT N FROM T2);

The above query may be viewed generally as A INTERSECT (B MINUS C). If set A is selected as a build branch where the result set D of B MINUS C probes the hash map built on set A, then to obtain result set D, a second hash map must be built on build branch B and C used to probe the second hash map. In total, two hash maps are built. Fortunately, this query Q12 can be rewritten equivalently to query Q11 because of the commutative property of INTERSECT. In that case, only one hash map must be built as described above with respect to query Q11.

When selecting a build branch in a multiple branch query, the techniques described above for use with the two-branch case can also be used in the multiple branch case. In particular, a branch may be selected as the build branch based on a query hint or based on the number of distinct records in the branch.

### Aggregation Rules for Multiple Branches

For a multiple branch query, one branch is a build branch and all other branches are probe branches.

### Multiple Branch Minus and Minus all

The aggregation rules for MINUS and MINUS ALL remain the same as in the two-branch case described above. For example, for A MINUS B MINUS C, matched records that exist in probe branches B and C can be aggregated by removing the matched records from the hash map or by setting the MF flag 409 for the corresponding packed records as described above with respect to operation 648 of FIG. 6. As another example, for A MINUS ALL B MINUS ALL C, matched records that exist in probe branches B and C can be aggregated by managing the #RP field 418 of the corresponding packed records as described above with respect to operation 982 of FIG. 9.

### Multiple Branch Intersect

For A INTERSECT B INTERSECT C, the #RS field 414 of packed records corresponding to matched records is managed as described below to determine whether the matched record occurs in each of the multiple branches A, B, and C. In particular, the #RS field 414 of a packed record is used to store the number of probe branches of the query that contain the corresponding record. When the hash map is built during the build phase, new records are added to the hash map with an initial value for the #RS field 414 of zero. Duplicate records in the build branch are skipped during the build phase.

After the hash map is built based on the build branch A, the hash map may be probed by each probe branch B and C. When probing the hash map during the probe phase, records not in the hash map are skipped.

However, if a record in a probe branch is found in the hash map, the value of the #RS field 414 of the corresponding packed record is incremented by one if this is the first time the record was matched in the current probe branch and the record occurred at least once in the previous probe branch if there was a previous probe branch. The value of the #RS field 414 of the corresponding packed record is not incremented for second and subsequent occurrences of the record in the current probe branch.

If a matched record exists in a probe branch (e.g., C) but not in the previous probe branch (e.g., B) according to the value of the #RS field 414 of the corresponding packed record, then the matched record may be removed from the hash map. By doing so, the matched record cannot be matched again for subsequent probe branches thereby conserving computing resources by avoiding having to access the corresponding packed record in computer memory to determine whether the matched record occurred in the previous probe branch.

For a record not in the last probe branch (e.g., C) but in all of the previous probe branches (e.g., B), since there is no probe branch following the last probe branch, the record cannot be removed when processing the following probe branch as is done with the earlier probe branches. As such, a record in the last probe branch is not produced in the result set if the value of #RS field 414 of the corresponding packed record is less than the total number of probe branches. If the value of #RS field 414 of the corresponding packed record is equal to the total number of probe branches, the record is produced in the result set.

As an example, for a query statement such as A INTERSECT B INTERSECT C INTERSECT D where record “Alice” exists in set A, set B, and set D, but not in set C, then the “Alice” record would be inserted into the hash map when building the hash map based on build branch A with the corresponding packed record having an initial value of the #RS field 414 of zero. All repeats of “Alice” in build branch A would be skipped during the build phase. Sets B, C, and D would each be taken as probe branches and assigned probe branch indices of 1, 2, and 3, respectively.

When the “Alice” record occurs for the first time in set B during the probe phase using set B, the value of the #RS field 414 of the packed record for the “Alice” record would be zero (0) which is one less than the probe branch index of set B. Therefore, the value of the #RS field 414 of the packed record would be increased by one (1) from zero (0) to one (1). For any additional occurrences of the “Alice” record in set B, the value of the #RS field 414 of the packed record would be equal to the branch index of set B. Therefore, the additional occurrences would be skipped.

The “Alice” record does not appear in set C. Therefore, the value of the #RS field 414 of the packed record would not be incremented when processing set C.

When processing set D and the first occurrence of the “Alice” record is seen in set D, the value of the #RS field 414 of the packed record would be more than one less than the probe branch index of set D which means that the “Alice” record did not occur in the previous probe branch. Therefore, in this case, the packed record for the “Alice” record can be removed from the hash map since it was determined that the “Alice” record does not exist in all of sets A, B, C, and D.

### Multiple Branch Intersect all

For INTERSECT ALL, the packed record for each distinct record may use #RP field 418, #RS field 414, and #MRP field 424. #MRP field 414 counts the minimum number of repeats of the corresponding record among all branches, build and probe. Optional #RS field 414 may be used the same as in INTERSECT in the multiple branch case described above. #RP field 418 counts the number of repeats of the record in the current branch starting with the build branch.

Each time a matched record is seen in the first probe branch after processing the build branch, the value of the #MRP field 414 in the corresponding packed record replaces the value of the #MRP field 424 in the corresponding packed record. Each time a matched record is first seen in a second or subsequent probe branch after processing the previous probe branch, the value of #RP field 418 in the corresponding packed record replaces the value of #MRP field 424 in the corresponding packed record if the value of the #RP field 418 is less than the value of the #MRP field 414. In this way, the minimum number of occurrences of the record in one branch is tracked during the probe phase.

During the scan and produce phases, the number of instances of a given record to include in the result set is taken as the minimum of the value of the #RP field 418 and the value of the #MRP field 424 of the corresponding packed record.

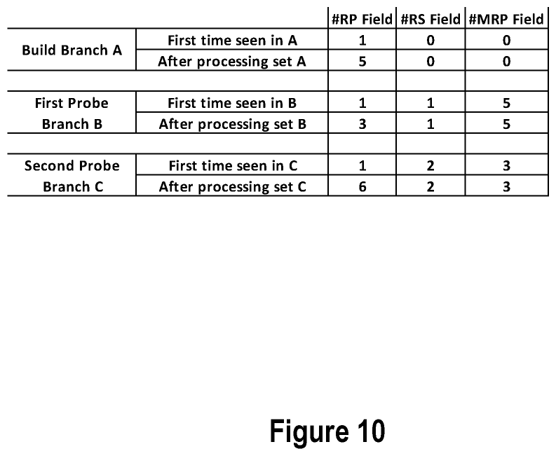

FIG. 10 illustrates an example of how the values of #RS field 414, #RP field 418, and #MRP field 424 change, according to some embodiments of the present invention. For this example, the multiple branch query may be “A INTERSECT ALL B INTERSECT ALL C” where sets A, B, and C represent the result sets of component queries. Further assume that the “Alice” record exists and repeats five (5) times in set A, three (3) times in set B, and six (6) times in set C. Set A is selected as the build branch and sets B and C are probe branches assigned probe indices 1 and 2, respectively.

The first time the “Alice” record is seen in build branch A, a packed record for the “Alice” record is stored in computer memory with an initial value of one (1) for #RP field 418. The values of #RS field 414 and #MRP field 424 are both initialized to zero.

After build branch set A has been processed, the value of #RP field 418 is five (5) indicating that are five (5) instances of the “Alice” record in set A. The values of #RS field 414 and #MRP field 424 remain zero.

The first time the “Alice” record is seen in the first probe branch set B, the value of #MRP field 424 is zero and the value of the #RP field 418 is five (5) which is the number of repeats of the “Alice” record in the build branch set A. Therefore, the value of #MRP field 424 is set to the value of the #RP field 418 to represent the current minimum number of repeats of the “Alice” record among all completely processed branches. At this point only the build branch set A has been completely processed. The value of the #RP field 418 is then set to one (1) to indicate that one occurrence of the “Alice” record has been seen once in probe branch B. In addition, the value of the #RS field 414 is incremented by one since the value of the #RS field 414 before the increment was zero (0), or one less than the current probe branch index of set B, which is one (1).

After probe branch set B has been processed, the value of #RP field 418 is three (3) indicating that are three (3) instances of the “Alice” record in set B. The values of #RS field 414 and #MRP field 424 remain one (1) and five (5), respectively.

The first time the “Alice” record is seen in the second probe branch set C, the value of #MRP field 424 is five (5) and the value of the #RP field 418 is three (3) which is the number of repeats of the “Alice” record in the first probe branch set B. Therefore, the value of #MRP field 424 is set to the value of the #RP field 418 (i.e., three (3)) to represent the current minimum number of repeats of the “Alice” record among all completely processed branches. At this point the build branch set A and the first probe branch set B have been completely processed. The value of the #RP field 418 is then set to one (1) to indicate that one occurrence of the “Alice” record has been seen in second probe branch set C. In addition, the value of the #RS field 414 is incremented by one since the value of the #RS field 414 before the increment was one (1), or one less than the current probe branch index of set C, which is one (2).

After probe branch set C has been processed, the value of #RP field 418 is six (6) indicating that are six (6) instances of the “Alice” record in set C. The values of #RS field 414 and #MRP field 424 remain two (2) and three (3), respectively. The “Alice” record will be included or counted three (3) times in the final result set since three (3) is the smallest number of repeats of the “Alice” record among all build and probe branches as indicated by the final value of #MRP field 424 and the final value of #RP field 418 of the corresponding packed record for the “Alice” record.

### Mixture of Set Operations

According to some embodiments, the hash-based approach is used to perform a mixture of INTERSECT, MINUS, INTERSECT ALL, and MINUS ALL set operations in a database query language statement that contains more than two branches. In particular, the mixture of set operations may include any of the following mixtures after any query transformations are performed.
any mixture of INTERSECT and MINUS (i.e., any mixture of non-ALL set operations),
any mixture of INTERSECT ALL and MINUS ALL (i.e., any mixture of ALL set operations), and
some mixtures of ALL and non-ALL operators.

A query transformation may be performed on an input query as part of query processing by the database management system to transform the input query to a semantically equivalent form that is more optimal for execution against the database. For a query that contains set operations, query transformation may involve, for example, reordering set operations, eliminating unnecessary set operations, and replacing set operations.

In the some mixtures case above, it may not be necessary to perform an ALL operation. For example, consider the following SQL statement:

### Q13: SELECT N FROM T1 MINUS

SELECT N FROM T2 MINUS ALL
SELECT N FROM T3;

Since the output of the MINUS set operation is unique, it is unnecessary to count the number of duplicates in the branch selected from database object T3. Thus, for optimized execution of the query, the MINUS ALL set operation in the above query may be transformed to a MINUS set operation before the query is executed. The database management system may do this transformation during semantic analysis of the SQL statement, for example. On the other hand, if a MINUS set operation has lower precedence than a MINUS ALL operation, then the MINUS ALL set operation cannot be transformed to a MINUS set operation.

The hash-based approach can leverage the commutative property of INTERSECT and INTERSECT ALL. In particular, if a database query language statement contains an INTERSECT set operation and an INTERSECT ALL set operation, then the INTERSECT ALL operation can be transformed to an INTERSECT set operation. Further, INTERSECT ALL can be transformed to INTERSECT if the intermediate set operation preceding or following the INTERSECT ALL set operation, if one exists, is INTERSECT or MINUS.

For a query with a mixture of ALL and non-ALL set operations that includes at least one MINUS ALL set operation, only non-ALL set operations can have lower precedence than the lowest precedence MINUS ALL set operation in the query after all query transformations have been performed. However, INTERSECT ALL or MINUS ALL set operations may have higher precedence than the lowest precedence MINUS ALL set operation in the query after any query transformations have been performed.

### Multiple Branch Mixtures

As mentioned above, the hash-based approach supports different mixtures of set operations including:
1. A mixture of INTERSECT and MINUS set operations.
2. A mixture of MINUS ALL and MINUS set operations.
3. A mixture of MINUS ALL and INTERSECT set operations.
4. A mixture of MINUS, ALL, INTERSECT, and MINUS set operations.
5. A mixture of INTERSECT ALL and MINUS ALL.
6. A mixture of INTERSECT ALL, MINUS ALL, and MINUS.
7. A mixture of INTERSECT ALL, MINUS ALL, and INTERSECT.
8. A mixture of INTERSECT ALL, MINUS ALL, INTERSECT, and MINUS.

In the above possible mixtures, all respective aggregation rules are the same for each single set operation. The extra work area information in each packed record for case 1 above may be the same as the multiple branch INTERSECT case described above. The extra work area information in each packed record for case 2 above may the same as the multiple branch MINUS ALL case described above. The extra work area information in each packed record for cases 5, 6, 7, and 8 above may be the same as the multiple branch INTERSECT ALL case described above. For cases 3 and 4 above, #RP field 418 and #RS field 414 may be used but using the aggregation rules of the multiple branch MINUS ALL and INTERSECT cases described above.

### Extensions and Alternatives

Examples of the hash-based approach are discussed herein in the context of example database query language statements. While the hash-based approach may be used to produce a result set of records for a database query based on a database query language statement, the hash-based approach can also be used to produce a result set of records for a query block or a subquery of a database query language statement. Generally, the hash-based approach may be used to produce a result set of records for a database query comprising one or more set operations and two or more input branches to the one or more set operations. The database query can correspond to a database query language statement or a subquery or a query block thereof.

Further, while examples are provided herein using the Structured Query Language (SQL) database query language, the hash-based approach may be used in other contexts including in the context of different database query languages that support set operations such as, for example, other database query languages that support relational algebra-based operations.

### Database Management System Overview

The disclosed techniques may be used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources provide a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as ORACLE. SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any type of data container or database architecture. However, for the purpose of explanation, the examples and the terminology used herein shall be that typically associated with relational or object-relational databases. Thus, the terms “table,” “row,” and “column” shall be used herein to refer respectively to the data container, record, and field.

A multi-node database management system is made up of interconnected nodes that share access to the same database. Typically, the nodes are interconnected via a network and share access, in varying degrees, to shared storage such as, for example, shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A client may issue a series of requests, such as requests for execution of queries, to a DBMS by establishing a database session. A database session comprises a particular connection established for a client to a database server through which the client may issue the series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user defined execution context such as a user thread or fiber. Database processes may also include “database server system” processes which provide services and/or perform functions on behalf of entire database server. Such database server system processes include listeners, garbage collectors, log writers, and recovery processes.

A database dictionary may comprise multiple data structures that store database metadata. A database dictionary may for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the column names and datatypes of the columns, and one or more files or portions thereof that store data for the table. Metadata in the database dictionary defining a procedure may specify a name of the procedure, the procedure's arguments and the return datatype and the datatypes of the arguments and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user defined function implemented in a JAVA class may be defined in part by the database dictionary by specifying the name of the users defined function and by specifying a reference to a file containing the source code of the JAVA class and the compiled version of the class.

Query optimization generates one or more different candidate execution plans for a query, which are evaluated by the query optimizer to determine which execution plan should be used to compute the query.

Execution plans may be represented by a graph of interlinked nodes, referred to herein as operators or row sources, that each corresponds to a step of an execution plan, referred to herein as an execution plan operation. The hierarchy of the graphs represents the order in which the execution plan operations are performed and how data flows between each of the execution plan operations. An execution plan operator generates a set of rows (which may be referred to as a table) as output and execution plan operations include, for example, a table scan, an index scan, sort-merge join, nested-loop join, filter, and importantly, a full outer join.

A query optimizer may optimize a query by transforming the query. In general, transforming a query involves rewriting a query into another semantically equivalent query that should produce the same result and that can potentially be executed more efficiently such as, for example, one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Cloud Computing

The disclosed techniques may be implemented in a “cloud computing” environment. The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the public. In contrast, a private cloud environment is generally intended solely for use by, or within, a single organization. A community cloud is intended to be shared by several organizations within a community; while a hybrid cloud comprises two or more types of clouds (e.g., private cloud, community cloud, or public cloud) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment such as, for example, aspects below the run-time execution environment. Infrastructure as a Service (IaaS), in which consumers can deploy and run arbitrary software applications, and/or provision processing, storage, networks, and other fundamental computing resources, while an IaaS provider manages or controls the underlying physical cloud infrastructure such as, for example, aspects below the operating system layer. Database as a Service (DBaaS) in which consumers use a database server or Database Management System that is running upon a cloud infrastructure, while a DBaaS provider manages or controls the underlying cloud infrastructure, applications, and servers, including one or more database servers.

### Basic Computing Device

The disclosed techniques may be implemented by at least one computing device. If by more than one computing device, the techniques may be implemented in whole or in part using a combination of computing devices that are coupled together using a network, such as a packet-based data network.

A computing device used in an implementation of the techniques may be hard-wired to perform some or all of the techniques, or may include digital electronic devices such as at least one application-specific integrated circuit (ASIC) or field programmable gate array (FPGA) that is persistently programmed to perform some or all of the techniques, or may include at least one general purpose hardware processor programmed to perform some or all of the techniques pursuant to program instructions in firmware, memory, other storage, or a combination.

A computing device used in an implementation of the techniques may also combine custom hard-wired logic, ASICs, or FPGAs with custom programming to accomplish some or all the techniques.

A computing device used in an implementation of the techniques may be a server computing device, a workstation computing device, a personal computing device, a portable computing device, a handheld computing device, a mobile computing device or any other computing device that incorporates hard-wired or program logic to implement some or all the techniques.

FIG. 11 is a block diagram of an example basic computing device that may be used in an implementation of the techniques. In the example of FIG. 11, computing device 1100 and instructions for implementing some or all the techniques in hardware, software, or a combination of hardware and software, are represented schematically, for example as boxes and circles, at the same level of detail that is commonly used by persons of ordinary skill in the art to which this disclosure pertains for communicating about computer architecture and computing device implementations.

Computing device 1100 includes an input/output (I/O) subsystem 1102 which may include a bus or other communication mechanism for communicating information or instructions between the components of the computing device 1100 over electronic signal paths. The I/O subsystem 1102 may include an I/O controller, a memory controller and at least one I/O port. The electronic signal paths are represented schematically in the drawings, for example as lines, unidirectional arrows, or bidirectional arrows.

At least one hardware processor 1104 is coupled to I/O subsystem 1102 for processing information and instructions. Hardware processor 1104 may include, for example, a general-purpose microprocessor or microcontroller or a special-purpose microprocessor such as an embedded system or a graphics processing unit (GPU) or a digital signal processor or ARM processor. Processor 1104 may comprise an integrated arithmetic logic unit (ALU) or may be coupled to a separate ALU.

Computing device 1100 includes one or more units of memory 1106, such as a main memory, which is coupled to I/O subsystem 1102 for electronically digitally storing data and instructions to be executed by processor 1104. Memory 1106 may include volatile memory such as various forms of random-access memory (RAM) or other dynamic storage device. Memory 1106 also may be used for storing temporary variables or other intermediate information during execution of instructions to be executed by processor 1104. Such instructions, when stored in non-transitory memory accessible to processor 1104, can render computing device 1100 into a special-purpose machine that is customized to perform the operations specified in the instructions.

Computing device 1100 further includes non-volatile memory such as read only memory (ROM) 1108 or other static storage device coupled to I/O subsystem 1102 for storing information and instructions for processor 1104. The ROM 1108 may include various forms of programmable ROM (PROM) such as erasable PROM (EPROM) or electrically erasable PROM (EEPROM). A unit of persistent storage 1110 may include various forms of non-volatile RAM (NVRAM), such as FLASH memory, or solid-state storage, magnetic disk, or optical disk such as CD-ROM or DVD-ROM and may be coupled to I/O subsystem 1102 for storing information and instructions. Storage 1110 is an example of a non-transitory computer-readable medium that may be used to store instructions and data which when executed by the processor 1104 cause performing computer-implemented methods to execute some or all the techniques.

The instructions in memory 1106, ROM 1108 or storage 1110 may comprise one or more sets of instructions that are organized as modules, methods, objects, functions, routines, or calls. The instructions may be organized as one or more computer programs, operating system services or application programs including mobile apps. The instructions may comprise an operating system or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a database system using structured query language (SQL) or NoSQL, an object store, a graph database, a flat file system or other data storage.

Computing device 1100 may be coupled via I/O subsystem 1102 to at least one output device 1112. Output device 1112 may be a digital computer display. Examples of a display that may be used include a touch screen display or a light-emitting diode (LED) display or a liquid crystal display (LCD) or an e-paper display. Computing device 1100 may include other types of output devices 1112, alternatively or in addition to a display device. Examples of other output devices 1112 include printers, ticket printers, plotters, projectors, sound cards or video cards, speakers, buzzers or piezoelectric devices or other audible devices, lamps or LED or LCD indicators, haptic devices, actuators, or servos.

An input device 1114 may be coupled to I/O subsystem 1102 for communicating signals, data, command selections or gestures to processor 1104. Examples of input devices 1114 include touch screens, microphones, still and video digital cameras, alphanumeric and other keys, keypads, keyboards, graphics tablets, image scanners, joysticks, clocks, switches, buttons, dials, slides, or various types of sensors such as force sensors, motion sensors, heat sensors, accelerometers, gyroscopes, and inertial measurement unit (IMU) sensors or various types of transceivers such as wireless, such as cellular or Wi-Fi, radio frequency (RF) or infrared (IR) transceivers and Global Positioning System (GPS) transceivers.

Another type of input device is a control device 1116, which may perform cursor control or other automated control functions such as navigation in a graphical interface on a display screen, alternatively or in addition to input functions. Control device 1116 may be a touchpad, a mouse, a trackball, or cursor direction keys for communicating direction information and command selections to processor 1104 and for controlling cursor movement on display 1112. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 1114 may include a combination of multiple different input devices, such as a video camera and a depth sensor.

Computing device 1100 may comprise an internet of things (IoT) device or other computing appliance in which one or more of output device 1112, input device 1114, and control device 1116 are omitted. The input device 1114 may comprise one or more cameras, motion detectors, thermometers, microphones, seismic detectors, other sensors or detectors, measurement devices or encoders and the output device 1112 may comprise a special-purpose display such as a single-line LED or LCD display, one or more indicators, a display panel, a meter, a valve, a solenoid, an actuator, or a servo.

When computing device 1100 is a mobile or portable computing device, input device 1114 may comprise a global positioning system (GPS) receiver coupled to a GPS module that is capable of triangulating to a plurality of GPS satellites, determining and generating geo-location or position data such as latitude-longitude values for a geophysical location of the computing device 1100. Output device 1112 may include hardware, software, firmware, and interfaces for generating position reporting packets, notifications, pulse or heartbeat signals, or other recurring data transmissions that specify a position of the computing device 1100, alone or in combination with other application-specific data, directed toward host 1124 or server 1130.

Computing device 1100 may implement some or all the techniques using customized hard-wired logic, at least one ASIC or FPGA, firmware or program instructions or logic which when loaded and used or executed in combination with computing device 1100 causes or programs computing device 1100 to operate as a special-purpose machine.

The techniques performed by computing device 1100 may be performed in response to processor 1104 executing at least one sequence of at least one instruction contained in main memory 1106. Such instructions may be read into main memory 1106 from another storage medium, such as storage 1110. Execution of the sequences of instructions contained in main memory 1106 causes processor 1104 to perform some or all the techniques. Hard-wired circuitry may be used in place of or in combination with software instructions.

The term “storage media” as used herein refers to any non-transitory computer-readable media that store data or instructions that cause a machine to operation in a specific fashion. Such storage media may comprise non-volatile media or volatile media. Non-volatile media includes, for example, optical or magnetic disks, such as storage 1110. Volatile media includes dynamic memory, such as memory 1106. Common forms of storage media include, for example, a hard disk, solid state drive, flash drive, magnetic data storage medium, any optical or physical data storage medium, memory chip or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1102. Transmission media can also take the form of acoustic or light waves, such as those generated during radio-wave and infra-red data communications.

Various forms of media may be involved in carrying at least one sequence of at least one instruction to processor 1104 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computing device 1100 can receive the data on the communication link and convert the data to be read by computing device 1100. For instance, a receiver such as a radio frequency antenna or an infrared detector can receive the data carried in a wireless or optical signal and appropriate circuitry can provide the data to I/O subsystem 1102 such as place the data on a bus. I/O subsystem 1102 carries the data to memory 1106, from which processor 1104 retrieves and executes the instructions. The instructions received by memory 1106 may optionally be stored on storage 1110 either before or after execution by processor 1104.

Computing device 1100 also includes a communication interface 1118 coupled to bus 1102. Communication interface 1118 provides a two-way data communication coupling to network link 1120 that is directly or indirectly connected to at least one communication networks, such as a network 1122 or a public or private cloud on the Internet. For example, communication interface 1118 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1122 broadly represents a local area network (LAN), wide-area network (WAN), campus network, internetwork, or any combination thereof. Communication interface 1118 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 1120 typically provides electrical, electromagnetic, or optical data communication directly or through at least one network to other data devices, using, for example, satellite, cellular, Wi-Fi, or BLUETOOTH technology. For example, network link 1120 may provide a connection through a network 1122 to a host computer 1124.

Furthermore, network link 1120 may provide a connection through network 1122 or to other computing devices via internetworking devices and/or computers that are operated by an Internet Service Provider (ISP) 1126. ISP 1126 provides data communication services through a world-wide packet data communication network represented as internet 1128. A server computer 1130 may be coupled to internet 1128. Server 1130 broadly represents any computer, data center, virtual machine, or virtual computing instance with or without a hypervisor, or computer executing a containerized program system such as DOCKER or KUBERNETES. Server 1130 may represent an electronic digital service that is implemented using more than one computer or instance and that is accessed and used by transmitting web services requests, uniform resource locator (URL) strings with parameters in HTTP payloads, API calls, app services calls, or other service calls.

Computing device 1100 and server 1130 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 1130 may comprise a web application server that hosts a presentation layer, application layer and data storage layer such as a database system using structured query language (SQL) or NoSQL, an object store, a graph database, a flat file system or other data storage.

Computing device 1100 can send messages and receive data and instructions, including program code, through a network, network link 1120 and communication interface 1118. In the Internet example, server 1130 might transmit a requested code for an application program through Internet 1128, ISP 1126, local network 1122 and communication interface 1118. The received code may be executed by processor 1104 as it is received, or stored in storage 1110, or other non-volatile storage for later execution.

### Basic Software System

FIG. 12 is a block diagram of an example basic software system 1200 that may be employed for controlling the operation of computing device 1100 of FIG. 11. Software system 1200 and its components, including their connections, relationships, and functions, is meant to be an example only, and not meant to limit implementations of the techniques. Other software systems suitable for implementing the techniques may have different components, including components with different connections, relationships, and functions.

Software system 1200 is provided for directing the operation of computer system 1100. Software system 1200, which may be stored in system memory (RAM) 1106 and on fixed storage (e.g., hard disk or flash memory) 1110, includes a kernel or operating system (OS) 1210.

OS 1210 manages low-level aspects of computer operation, including managing execution of processes, represented as 1202-1, 1202-2, 1202-3 . . . 1202-N, memory allocation, file input and output (I/O) and device I/O. One or more application programs may be “loaded” (e.g., transferred from fixed storage 1110 into memory 1106) for execution as one or more processes by the system 1200. The applications or other software intended for use on computing device 1100 may also be stored as a set of downloadable computer-executable instructions, for example, for downloading and installation from an Internet location (e.g., a Web server, an app store or other online service).

The execution of application program instructions may implement a process (e.g., 1202-2) in the form of an instance of a computer program that is being executed and consisting of program code and its current activity. Depending on the operating system (OS), a process (e.g., 1202-3) may be made up of multiple threads of execution that execute instructions concurrently. In this context, a computer program is a passive collection of instructions, while a process (e.g., 1202-1) may be the actual execution of those instructions. Several processes (e.g., 1202-1 and 1202-2) may be associated with the same program; for example, opening several instances of the same program often means more than one process is being executed, or a program that initially launches as a single process may subsequently spawn (e.g., fork) additional processes.

OS 1210 may implement multitasking to allow processes 1202-1, 1202-2, 1202-3 . . . 1202-N to share processor 1104. While each processor 1104 or core of the processor executes a single task at a time, computing device 1100 may be programmed to implement multitasking to allow each processor to switch between tasks that are being executed without having to wait for each task to finish. Switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. For security and reliability, OS 1210 may prevent direct communication between independent processes, providing strictly mediated and controlled inter-process communication functionality.

In some instances, processes 1202-1, 1202-2, 1202-3 . . . 1202-N and the application programs they implement may execute within application container 1240. Application containers generally are a mode of operation of OS 1210 in which OS 1210 allows the existence of multiple isolated user space instances to run on OS 1210. Application container 1240 is an example of one such instance. The instances themselves are sometimes alternatively referred to as zones, virtual private servers, partitions, virtual environments, virtual kernels, or jails. Application containers provide a mechanism whereby finite hardware computing resources such as CPU time and storage media space can be allocated among the instances.

Software system 1200 includes a graphical user interface (GUI) 1215, for receiving user commands and data in a graphical (e.g., “point-and-click” or “touch gesture”) fashion. These inputs, in turn, may be acted upon by system 1200 in accordance with instructions from operating system 1210 or processes 1202-1, 1202-2, 1202-3 . . . 1202-N. GUI 1215 also serves to display the results of operation from OS 1210 and processes 1202-1, 1202-2, 1202-3 . . . 1202-N 1202, whereupon the user may supply additional inputs or terminate the session (e.g., log off).

OS 1210 can execute directly on bare hardware 1220 (e.g., processor 1104) of computing device 1100. Alternatively, a hypervisor or virtual machine monitor (VMM) 1230 may be interposed between bare hardware 1220 and OS 1210. In this configuration, VMM 1230 acts as a software “cushion” or virtualization layer between OS 1210 and bare hardware 1220 of computing device 1100.

VMM 1230 instantiates and runs one or more virtual machine instances (“guest machines”). Each guest machine comprises a “guest” operating system, such as OS 1210, and one or more applications, such as applications 1202, designed to execute on the guest operating system. VMM 1230 presents the guest operating systems with a virtual operating platform and manages the execution of the guest operating systems.

In some instances, VMM 1230 may allow a guest operating system to run as if it is running on bare hardware 1220 of computing device 1100 directly. In these instances, the same version of the guest operating system configured to execute on the bare hardware 1220 directly may also execute on VMM 1230 without modification or reconfiguration. In other words, VMM 1230 may provide full hardware and CPU virtualization to a guest operating system in some instances.

In other instances, a guest operating system may be specially designed or configured to execute on VMM 1230. In these instances, the guest operating system is “aware” that it executes on a virtual machine monitor. In other words, VMM 1230 may provide para-virtualization to a guest operating system in some instances.

### OTHER ASPECTS OF THE DISCLOSURE

Unless the context clearly indicates otherwise, the term “or” is used in the foregoing specification and in the appended claims in its inclusive sense (and not in its exclusive sense) so that when used, for example, to connect a list of elements, the term “or” means one, some, or all the elements in the list.

Unless the context clearly indicates otherwise, the terms “comprising,” “including,” “having,” “based on,” “encompassing,” and the like, are used in the foregoing specification and in the appended claims in an open-ended fashion, and do not exclude additional elements, features, acts, or operations.

Unless the context clearly indicates otherwise, conjunctive language such as the phrase “at least one of X, Y, and Z,” is to be understood to convey that an item, term, etc. may be either X, Y, or Z, or a combination thereof. Thus, such conjunctive language is not intended to require by default implication that at least one of X, at least one of Y and at least one of Z to each be present.

Unless the context clearly indicates otherwise, as used in the foregoing detailed description and in the appended claims, the singular forms “a,” “an,” and “the” are intended to include the plural forms as well.

Unless the context clearly indicates otherwise, in the foregoing detailed description and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

In the foregoing specification, the disclosed techniques have been described with reference to numerous specific details that may vary from implementation to implementation. The specification and drawings are, accordingly, to be regarded in an illustrative rather than a restrictive sense

1. A method comprising:
receiving a database query indicating two or more set operations and three or more branches as inputs to the two or more set operations;
selecting one of the three or more branches as a build branch and the remaining of the three or more branches as probe branches;
populating a hash map based on records of the build branch;
probing the hash map with records of the probe branches including aggregating matched records; and
producing a result set of records for the database query based on the aggregating.

2. The method of claim 1, further comprising:
selecting a branch of the three or more branches as the build branch based on a hint in the database query.

3. The method of claim 1, further comprising:
selecting a branch of the three or more branches as the build branch based on an estimated number of distinct records of the branch.

4. The method of claim 1, further comprising:
storing records of the build branch in computer memory as a set of packed records;
determining a count or an estimate of a number of matched records; and
based on the count or the estimate of the number of matched records, determining whether to: (a) scan the set of packed records for records to include in the result set of records or (b) scan entries of the hash map for records to include in the result set of records.

5. The method of claim 4, further comprising:
based on the count or the estimate of the number of matched records being less than a threshold number, determining to scan the set of packed records for records to include in the result set of records; and
producing the result set of records based on scanning the set of packed records.

6. The method of claim 4, further comprising:
based on the count or the estimate of the number of matched records being greater than a threshold number, determining to scan entries of the hash map for records to include in the result set of records; and
producing the result set of records based on scanning entries of the hash map.

7. The method of claim 1, further comprising:
storing records of the build branch in computer memory as a set of packed records;
determining a count or an estimate of a number of records not matched; and
based on the count or the estimate of the number of records not matched, determining whether to: (a) scan the set of packed records for records to include in the result set of records or (b) scan entries of the hash map for records to include in the result set of records.

8. The method of claim 7, further comprising:
based on the count or the estimate of the number of records not matched being less than a threshold number, determining to scan entries of the hash map for records to include in the result set of records; and
producing the result set of records based on scanning entries of the hash map.

9. The method of claim 7, further comprising:
based on the count or the estimate of the number of records not matched being greater than a threshold number, scan the set of packed records for records to include in the result set of records; and
producing the result set of records based on scanning the set of packed records.

10. The method of claim 1, further comprising:
storing records of the build branch in computer memory as a set of packed records;
incrementing a repeat count for a packed record, of the set of packed records, corresponding to a matched record that repeats in a branch of the three or more branches; and
producing a number of instances of the matched record in the result set of records based on the repeat count for the packed record.

11. The method of claim 10, where in the number of instances equals the repeat count.

12. The method of claim 1, further comprising:
storing records of the build branch in computer memory as a set of packed records;
incrementing a field value for a packed record, of the set of packed records, corresponding to a matched record that exists in a previous probe branch; and
producing the matched record in the result set of records based on the field value for the packed record being equal to a total number of the probe branches.

13. The method of claim 1, further comprising:
storing records of the build branch in computer memory as a set of packed records;
determining a minimum number of repeats of a record in one branch among all the three or more branches; and
producing the record in the result set of records based on the minimum number of repeats of the record in one branch among all the three or more branches.

14. One or more non-transitory storage media comprising instructions which, when executed by one or more computing devices, cause:
receiving a database query indicating two or more set operations and three or more branches as inputs to the two or more set operations;
selecting one of the three or more branches as a build branch and the remaining of the three or more branches as probe branches;
populating a hash map based on records of the build branch;
probing the hash map with records of the probe branches including aggregating matched records; and
producing a result set of records for the database query based on the aggregating.

15. The one or more non-transitory storage media of claim 14, wherein:
the hash map is distributed over a plurality of computing nodes, and
the populating, the probing, and the producing operations are parallelized.

16. The one or more non-transitory storage media of claim 14, wherein two or more set operations comprise a plurality of intersect set operations.

17. The one or more non-transitory storage media of claim 14, wherein two or more set operations comprise a plurality of intersect all set operations.

18. A database management system comprising:
one or more computing devices;
storage media;
instructions stored in the storage media and which, when executed by the one or more computing devices, cause:
receiving a database query indicating two or more set operations and three or more branches as inputs to the two or more set operations;
selecting one of the three or more branches as a build branch and the remaining of the three or more branches as probe branches;
populating a hash map based on records of the build branch;
probing the hash map with records of the probe branches including aggregating matched records; and
producing a result set of records for the database query based on the aggregating.

19. The database management system of claim 18, further comprising:
instructions stored in the storage media and which, when executed by the one or more computing devices, cause:
storing records of the build branch in computer memory as a set of packed records; and
wherein each packed records of the set of packed records comprises one or more field value(s) of a corresponding record of the build branch.

20. The database management system of claim 18, wherein records of the build branch are obtained as a result of executing a component query of the database query against a database.
